(19) United States
(12) Patent Application Publication
(10) Pub. No.: US 2024/0005796 A1
(43) Pub. Date: Jan. 4, 2024

(54) DISPLAY CONTROL DEVICE, DISPLAY CONTROL METHOD, AND DISPLAY CONTROL PROGRAM

(71) Applicant: NIPPON TELEGRAPH AND TELEPHONE CORPORATION, Tokyo (JP)

(72) Inventors: Kenichi FUKUDA, Tokyo (JP); Atsuhiko MAEDA, Tokyo (JP); Kazuaki OBANA, Tokyo (JP); Sun Yeong KIM, Tokyo (JP); Yukio KIKUYA, Tokyo (JP)

(73) Assignee: NIPPON TELEGRAPH AND TELEPHONE CORPORATION, Tokyo (JP)

(21) Appl. No.: 18/035,084

(22) PCT Filed: Nov. 5, 2020
(86) PCT No.: PCT/JP2020/041379

§ 371 Date: May 2, 2023

(51) Int. Cl. G08G 1/00; G08G 1/0965; G08G 1/0968; G08G 1/0969

(52) U.S. Cl. CPC G08G 1/202; G08G 1/0965; G08G 1/096811; G08G 1/0969

(57) ABSTRACT

A display control device controls a display unit to display position information of an emergency vehicle, a predictive distribution of an occurrence point, and a risk level, the occurrence point representing a point at which a call for the emergency vehicle occurs, the risk level being determined depending on a time required for the emergency vehicle to arrive at the occurrence point after the call for the emergency vehicle occurs or a distance between the emergency vehicle and the occurrence point.

### TECHNICAL FIELD

The present technology relates to a display control device, a display control method, and a display control program.

### BACKGROUND ART

A technology related to a system for optimal operation of ambulance vehicles using emergency big data has conventionally been known (see, for example, Non Patent Literature 1). Non Patent Literature 1 discloses a technology aimed at shortening the time required for arrival at a scene and the time required for transport to a hospital when an ambulance takes a sick or injured person to the hospital.

### CITATION LIST

### Non Patent Literature

Non Patent Literature 1: National Research Institute of Fire and Disaster, Nippon Telegraph and Telephone Corporation, and NTT DATA Corporation, “System for optimal operation of ambulance vehicles using emergency big data has been confirmed to be effective—for reduction of ambulance transport time by real-time emergency demand prediction and the like”, [online], Nov. 26, 2018, [Searched on Oct. 16, 2020], Internet <URL:https://www.ntt.co.jp/news2018/1811/181126a.html>

### SUMMARY OF INVENTION

### Technical Problem

By the way, in some cases, an ambulance, which is an example of an emergency vehicle, when called for, takes a longer time than expected to arrive at the point where the ambulance call has been made depending on the dispatch status of the ambulance. In one example, consider the case where a fire station near a particular area dispatches all of its ambulances. In this case, any additional ambulance calls in this area are likely to cause a fire station far from the area to dispatch its ambulance to the calling area. In this case, although there is a nearby fire station, a distant fire station is caused to dispatch its ambulance to the relevant area, taking time for the ambulance to arrive.

One possible way to address such a situation is to have an ambulance moved ahead of time to an area, for example, far from the fire station or near a fire station where there is no ambulance on standby for dispatch. Examples of methods of determining how to pre-move an ambulance include a determination by a person, calculation by a system, or the like.

However, areas that are incapable of being covered by such ambulance deployment are generally affected by the real-time operational status of a plurality of ambulances. It is not easy for humans to consider such real-time operational status of each ambulance to determine the deployment of ambulances. Furthermore, the adequacy determination of the ambulance deployment by humans is challenging in any case, whether the ambulance deployment is determined by a human or a system, making it hard to obtain a feeling of reliability.

Further, collating the visualized demand prediction for ambulance calls with the current position of an ambulance for each area can evaluate ambulance deployment satisfaction. In addition to the position of the ambulance, further displaying the state of the ambulance, such as on standby or dispatching, or displaying only the ambulance in a predetermined state, is also possible. However, considering the whole area, it highly seems to be many areas where the demand for ambulances is predicted, and the number of ambulances is large. It is more challenging to make an appropriate decision considering such broad various types of information. The prior art fails to process such a wide variety of information appropriately and then provide information that allows a unique recognition or determination of ambulance deployment satisfaction, for example, such as index values using the time required for the ambulance to arrive.

The disclosed technology, which is made in view of the above-mentioned points, is intended to visualize places where it takes time for an emergency vehicle to arrive.

### Solution to Problem

A first aspect of the present disclosure is a display control device including: a display control unit configured to control a display unit to display position information of an emergency vehicle, a predictive distribution of an occurrence point, and a risk level, the occurrence point representing a point at which a call for the emergency vehicle occurs, the risk level being determined depending on a time required for the emergency vehicle to arrive at the occurrence point after the call for the emergency vehicle occurs or a distance between the emergency vehicle and the occurrence point.

A second aspect of the present disclosure is a display control method of causing a computer to execute processing including: controlling a display unit to display position information of an emergency vehicle, a predictive distribution of an occurrence point, and a risk level, the occurrence point representing a point at which a call for the emergency vehicle occurs, the risk level being determined depending on a time required for the emergency vehicle to arrive at the occurrence point after the call for the emergency vehicle occurs or a distance between the emergency vehicle and the occurrence point.

A third aspect of the present disclosure is a display control program for causing a computer to execute processing including: controlling a display unit to display position information of an emergency vehicle, a predictive distribution of an occurrence point, and a risk level, the occurrence point representing a point at which a call for the emergency vehicle occurs, the risk level being determined depending on a time required for the emergency vehicle to arrive at the occurrence point after the call for the emergency vehicle occurs or a distance between the emergency vehicle and the occurrence point.

### Advantageous Effects of Invention

According to the technology disclosed, it is possible to visualize a place where it takes time for an emergency vehicle to arrive.

### BRIEF DESCRIPTION OF DRAWINGS

FIG. 1 is a diagram illustrated to describe a predictive distribution according to the present embodiment.

FIG. 2 is a diagram illustrated to describe a risk level distribution according to the present embodiment.

FIG. 3 is a diagram illustrated to describe a risk level distribution according to the present embodiment.

FIG. 4 is a block diagram illustrating a hardware configuration of a display control device.

FIG. 5 is a block diagram illustrating a functional configuration of a display control device.

FIG. 6 is a diagram illustrated to describe position information of an ambulance.

FIG. 7 is a diagram illustrated to describe the position information and operational status of an ambulance.

FIG. 8 is a diagram illustrated to describe the position information and operational status of an ambulance.

FIG. 9 is a flowchart illustrating procedures of display control processing by the display control device according to a first embodiment.

FIG. 10 is a flowchart illustrating procedures of display control processing by the display control device according to a second embodiment.

FIG. 11 is a flowchart illustrating the procedure of risk level calculation processing by the display control device according to the second embodiment.

FIG. 12 is a flowchart illustrating procedures of display control processing by the display control device according to a third embodiment.

### DESCRIPTION OF EMBODIMENTS

Hereinafter, an example of an embodiment of the disclosed technology will be described with reference to the drawings. In the drawings, the same or equivalent components and portions are denoted by the same reference numerals. In addition, dimensional ratios in the drawings are exaggerated for convenience of description, and may be different from actual ratios.

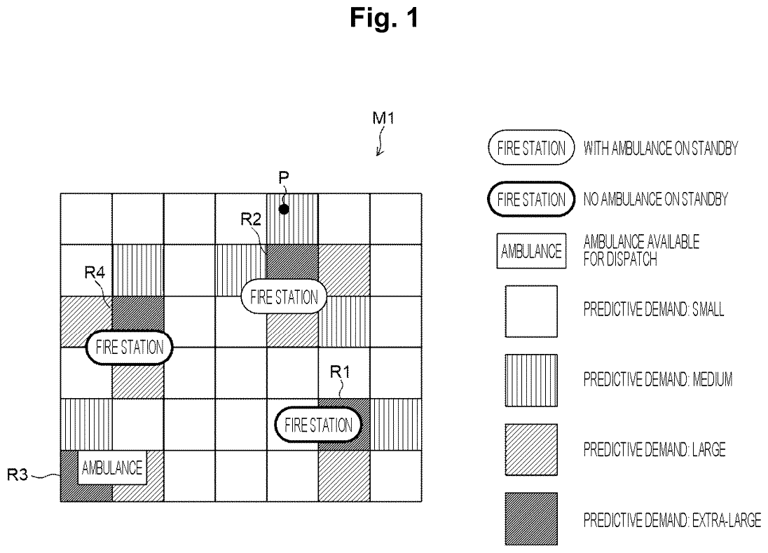

FIGS. 1 to 3 are diagrams illustrated to describe the overview of the present embodiment.

FIG. 1 is one example of a predictive distribution M1 for an occurrence point P representing a point where an ambulance call occurs. Such an ambulance is an example of an emergency vehicle. In the predictive distribution M1 of FIG. 1, the occurrence points P where the call is predicted to occur are plotted on the map data partitioned into a plurality of meshes. In the predictive distribution M1, the demand for calling is predicted for each mesh.

As illustrated in FIG. 1, this predictive distribution visualizes the occurrence point where a call is predicted to occur. However, the predictive distribution illustrated in FIG. 1 does not visualize the amount of time to be required for an ambulance to arrive at an occurrence point where an ambulance call has occurred. In the example illustrated in FIG. 1, regions R1, R3, and R4 have the predictive demand of “extra-large” and are located near a fire station with ambulances on standby or near an ambulance available to dispatch. Thus, the regions R1, R3, and R4 are expected that the time required for an ambulance to arrive will be relatively short. On the other hand, a region R2 in FIG. 1 has the predictive demand of “extra-large” and is located near a fire station, but this fire station has no ambulance on standby. Thus, the region R1 is expected that the time it takes for an ambulance to arrive will be relatively long.

Thus, the present embodiment visualizes a place where it takes time for an emergency vehicle to arrive.

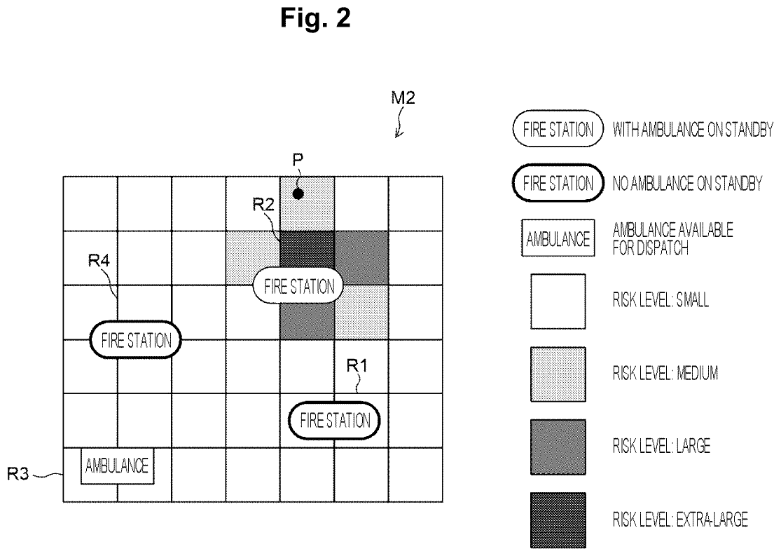

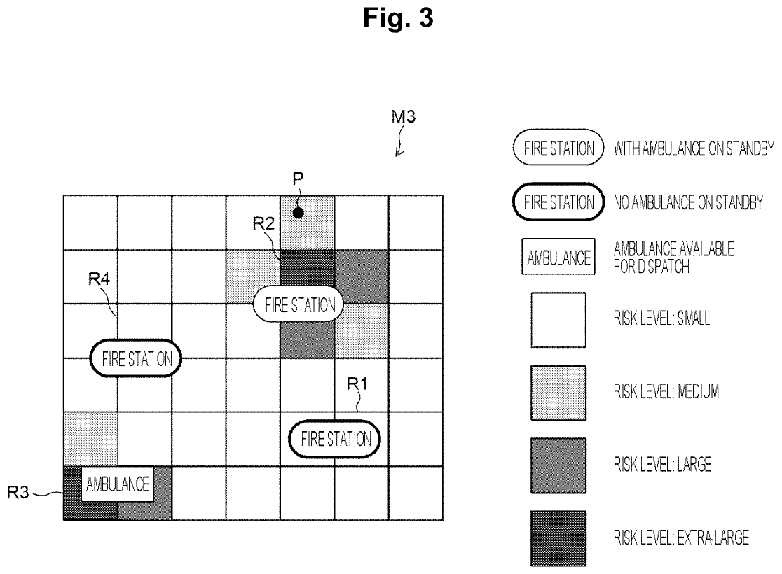

FIGS. 2 and 3 are diagrams illustrating an example of a risk level distribution M2 generated according to the present embodiment. As illustrated in FIG. 2, the risk level distribution M2 has the region R2 with the risk level of “extra-large” and has visualized places where it takes time for an emergency vehicle to arrive.

Moreover, the risk level can be visualized for only an ambulance on standby at a fire station rather than all ambulances available for dispatch. This configuration allows the visualization to be made so that the risk level of the area far from an ambulance on standby at a fire station is higher. Using this risk level allows a route for an ambulance outside a fire station to be set. In addition, upon setting the route for an ambulance outside a fire station, it is possible to use such a risk level to determine the adequacy of the route.

In one example, as illustrated in FIG. 3, the region R3 in the risk level distribution M3 also has the risk level of “extra-large” and visualizes the risk level of the place where it takes time for an emergency vehicle to arrive. In the example of FIG. 3, the region R3 has a large risk level even though an ambulance is nearby. This is because the region R3 has a nearby ambulance being moving and is far from a fire station where an ambulance is on standby. On the other hand, the region R4 has the risk level of “small” because there is a fire station nearby where an ambulance is on standby.

As described above, the present embodiment calculates and visualizes the risk level of a region not covered by the ambulance. Moreover, the present embodiment considers the operational status of the ambulance is considered and uses location information of an ambulance available for dispatch, allowing an uncovered occurrence point being not covered to be extracted. Further, in the present embodiment, considering the ease of dispatching an ambulance available for dispatch, the occurrence points existing near the ambulance that is easy to dispatch are set so that their risk levels are higher. This configuration makes it possible to visualize a place where it takes time for an emergency vehicle, for example, an ambulance, to arrive in the case where the emergency vehicle is called. In addition, the present embodiment makes it also possible to support the work of deploying ambulances.

### First Embodiment

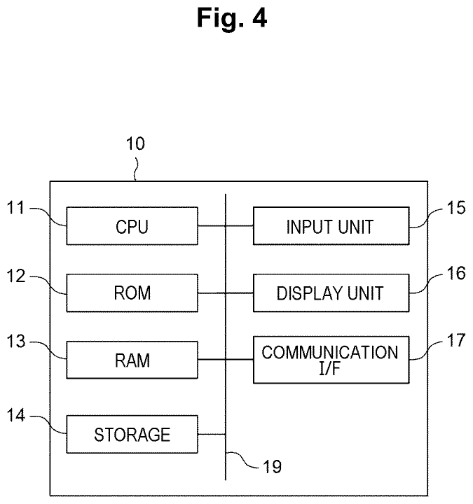

FIG. 4 is a block diagram illustrating a hardware configuration of a display control device 10.

As illustrated in FIG. 4, the display control device 10 includes a central processing unit (CPU) 11, a read only memory (ROM) 12, a random access memory (RAM) 13, a storage 14, an input unit 15, a display unit 16, and a communication interface (I/F) 17. The components are communicably connected to each other via a bus 19.

The CPU 11 is a central processing unit, and executes various programs and controls each unit. That is, the CPU 11 reads the program from the ROM 12 or the storage 14, and executes the program using the RAM 13 as a work region. The CPU 11 performs control of each of the above-described components and various types of operation processing according to a program stored in the ROM 12 or the storage 14. In the present embodiment, the ROM 12 or the storage 14 stores a language processing program for converting a voice input by the mobile terminal 20 into a character.

The ROM 12 stores various programs and various types of data. The RAM 13 functions as a work region to temporarily store programs or data. The storage 14 includes a storage device such as a hard disk drive (HDD) or a solid state drive (SSD), and stores various programs including an operating system and various types of data.

The input unit 15 includes a pointing device such as a mouse and a keyboard, and is used to perform various inputs.

The display unit 16 is, for example, a liquid crystal display, and displays various types of information. The display unit 16 may function as the input unit 15 by adopting a touch panel system.

The communication interface 17 is an interface for communicating with another device such as a portable terminal. For the communication, for example, a wired communication standard such as Ethernet (registered trademark) or fiber distributed data interface (FDDI), or a radio communication standard such as 4G, 5G, or Wi-Fi (registered trademark) is used.

Next, a functional configuration of the display control device 10 will be described.

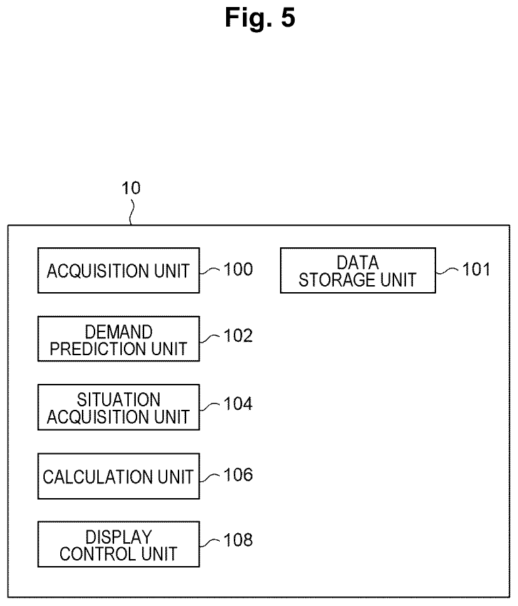

FIG. 5 is a block diagram illustrating an example of the functional configuration of the display control device 10.

As illustrated in FIG. 5, the display control device 10 includes, as functional configurations, an acquisition unit 100, a data storage unit 101, a demand prediction unit 102, a situation acquisition unit 104, a calculation unit 106, and a display control unit 108. Each functional configuration is achieved by the CPU 11 reading a display control program stored in the ROM 12 or the storage 14, loading the learning program in the RAM 13, and executing the learning program.

The acquisition unit 100 acquires various types of data from a command board system (not illustrated) in which various types of data of each one of a plurality of ambulances are collected. In addition, the acquisition unit 100 may acquire various types of data from an external server (not illustrated) different from the command board system. Then, the acquisition unit 100 stores the acquired various types of data in the data storage unit 101.

The data storage unit 101 stores various types of data acquired by the acquisition unit 100. For example, the data stored in the data storage unit 101 includes, for each one of the plurality of ambulances, a dispatch availability status of the ambulance, position information of the ambulance, position information of the fire station to which the ambulance is assigned, identification information of the fire station to which the ambulance is assigned, and information indicating a combination of a position from which the ambulance was called in the past and time, and the like. Thus, new data is stored every moment in the data storage unit 101.

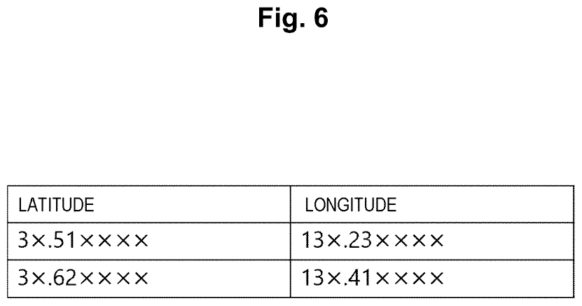

The demand prediction unit 102 generates a predictive distribution representing a demand prediction of occurrence points indicating positions from which the ambulance is called. In one example, the demand prediction unit 102 generates a predictive distribution of the occurrence point on the basis of the information, which is stored in the data storage unit 101 and represents a combination of the position and time where the ambulance was called in the past. In one example, the demand prediction unit 102 performs sampling on the points for each mesh on the basis of the points where the calls are made in the past for each mesh representing a particular region on the map data. The demand prediction unit 102 then obtains latitude and longitude information of a plurality of occurrence points that are expected to be called for each mesh on the map data. Moreover, if the number of occurrence points can be predicted by month or day of the week, as a simpler method, the demand prediction unit 102 can extract the data corresponding to the same month or day of the week in the past and use the latitude and longitude information as the position information of the occurrence point. In this case, for example, the latitude and longitude information, such as being illustrated in FIG. 6, can be obtained as the position information of the occurrence point.

Alternatively, for example, the demand prediction unit 102 may generate the predictive distribution of occurrence points by using a learned model that has been trained in advance by machine learning with the use of emergency transport information, information regarding past population of each place, information regarding past weather of each place, and the like.

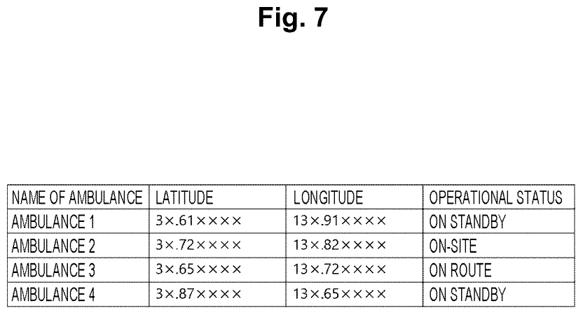

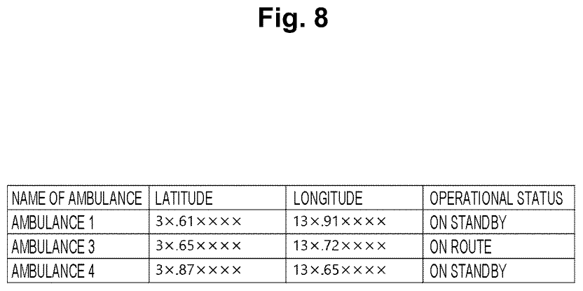

The situation acquisition unit 104 acquires information regarding an ambulance available for dispatch from the data storage unit 101. In one example, the situation acquisition unit 104 acquires information regarding an ambulance available for dispatch by acquiring the data as illustrated in FIG. 8 from the data stored in the data storage unit 101 and illustrated in FIG. 7.

Examples of an ambulance available for dispatch include an ambulance on standby at a fire station, an ambulance moving outside a fire station, such as ambulances on its way back or moving to another fire station, and an ambulance on standby somewhere outside a fire station. Moreover, in FIGS. 7 and 8, an ambulance with the operational status of “ON ROUTE” (on the route) represents a situation where the ambulance is not on standby at the fire station but is available for dispatch. Moreover, the situation acquisition unit 104 may not necessarily acquire “NAME OF AMBULANCE” (name of the ambulance), that is, identification information used to identify an ambulance in this data processing procedure.

The calculation unit 106 calculates the risk level depending on the distance between one ambulance among a plurality of ambulances and the occurrence point on the basis of the position information of the plurality of ambulances acquired by the situation acquisition unit 104 and the predictive distribution generated by the demand prediction unit 102.

Specifically, the calculation unit 106 specifies a target ambulance for each of a plurality of occurrence points in the predictive distribution generated by the demand prediction unit 102. The target ambulance indicates an ambulance having the shortest distance to the occurrence point among a plurality of ambulances.

In this configuration, given that N is a set of occurrence points and A is a set of ambulances available for dispatch. In this case, a distance dᵢⱼ when an ambulance j is called at an occurrence point i is calculated. Moreover, i is an element of N, and j is an element of A. In this case, a distance dᵢ from the occurrence point i to the nearest ambulance is expressed by Formula (1) below.

$$\begin{matrix}[ Math . 1 ] & \\ {d}_{i} = {min}_{j} {d}_{ij} & ( 1 )\end{matrix}$$

The calculation unit 106 then extracts the occurrence point, where the distance dᵢ between the target ambulance and the occurrence point i is equal to or greater than a threshold value dₜₕ, among the plurality of occurrence points. This allows a set of occurrence points {i|dₜₕ<dᵢ} existing at a position far from the nearest ambulance to be extracted.

The calculation unit 106 then plots the extracted occurrence points on the map data partitioned into the plurality of meshes. The calculation unit 106 calculates the risk level for each mesh included in the map data. The risk level is calculated so that the larger the number of occurrence points included in the mesh, the higher the risk level, and the smaller the number of occurrence points included in the mesh, the lower the risk level.

The display control unit 108 controls the display unit 16 to display the position information of the plurality of ambulances acquired by the situation acquisition unit 104, the predictive distribution generated by the demand prediction unit 102, and the risk level calculated by the calculation unit 106. The display control unit 108 visualizes the risk level of each mesh included in the map data. Moreover, the predictive distribution may not necessarily be displayed, and only the risk level can be visualized.

Next, operations of the display control device 10 will be described.

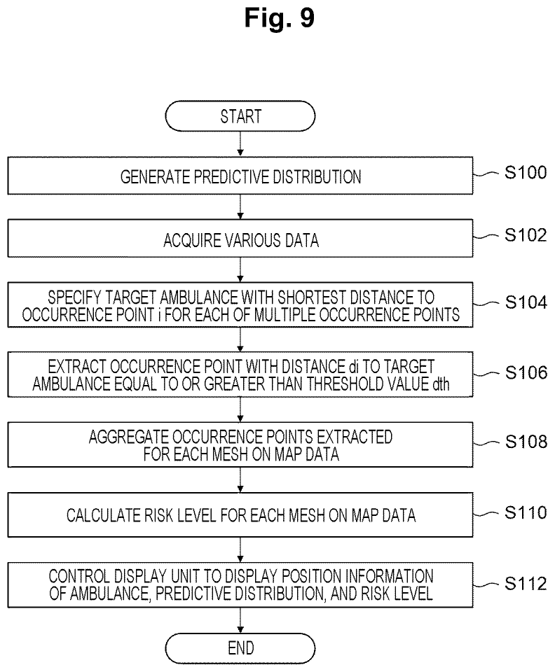

FIG. 9 is a flowchart illustrating procedures of display control processing by the display control device 10. The display control processing is performed by a CPU 11 reading a display control processing program from a ROM 12 or a storage 14, loading the display control processing program in a RAM 13, and executing the display control processing program.

In step S100, the CPU 11, as the demand prediction unit 102, generates a predictive distribution representing a demand prediction of occurrence points indicating positions from which the ambulance is called.

In step S102, the CPU 11, as the situation acquisition unit 104, the situation acquisition unit 104 acquires, for each one of the plurality of ambulances, a dispatch availability status of the ambulance, position information of the ambulance, position information of the fire station to which the ambulance is assigned, and identification information of the fire station to which the ambulance is assigned, and the like, from the data storage unit 101.

In step S104, the CPU 11 functions as the calculation unit 106 to specify a target ambulance among the plurality of ambulances for each of the plurality of occurrence points in the predictive distribution generated in step S100. The target ambulance indicates the ambulance having the shortest distance to the occurrence point.

In step S106, the CPU 11 functions as the calculation unit 106 to extract an occurrence point at which the distance between the target ambulance specified in step S104 and the occurrence point is equal to or greater than a threshold value among the plurality of occurrence points.

In step S108, the CPU 11 functions as the calculation unit 106 to plot the occurrence point extracted in step S106 on the map data partitioned into the plurality of meshes. The calculation unit 106 then aggregates the number of occurrence points for each mesh included in the map data.

In step S110, the CPU 11 functions as the calculation unit 106 to calculate the risk level for each mesh included in the map data so that the larger the number of occurrence points included in the mesh, the higher the risk level, and the smaller the number of occurrence points included in the mesh, the lower the risk level.

In step S112, the CPU 11 functions as the display control unit 108 to control the display unit 16 to display the position information of the plurality of ambulances acquired in step S102, the predictive distribution generated in step S100, and the risk level calculated in step S110.

As described above, the display control device according to the first embodiment causes the display unit to display the position information of an ambulance, which is an example of an emergency vehicle, the predictive distribution of an occurrence point indicating the point where the ambulance call occurs, and the risk level corresponding to the distance information indicating the distance between the ambulance and the occurrence point. This configuration makes it possible to visualize the place where it takes time for the emergency vehicle to arrive in the case where the emergency vehicle is called.

### Second Embodiment

Next, a second embodiment will be described. The second embodiment differs from the first embodiment in that an ambulance is set in the center of a cluster, and the occurrence point is assigned to the cluster, calculating the risk level on the basis of the result. Note that a display control device according to the second embodiment has a configuration similar to that of the first embodiment, and the same reference numerals are given and description thereof is omitted.

An ambulance, if it is the closest target ambulance to a plurality of occurrence points, is easier to dispatch. In this case, even if the ambulance is nearby, the risk levels of the occurrence points need to be higher.

Thus, in the second embodiment, a cluster centered on ambulances is configured for each ambulance, and a region included in the cluster is set as the region where the ambulance can meet the demand, calculating the risk level. Moreover, the cluster is, for example, a region indicating a predetermined range in the real space. Specifically, the second embodiment associates each occurrence point with a target ambulance, clustering the plurality of occurrence points. The target ambulance is an ambulance available for dispatch and the closest ambulance to the occurrence point. In this case, as many clusters as the number of ambulances available for dispatch are set. The set of occurrence points included in the cluster is the set of occurrence points existing within the range covered by the ambulance that is set in the center of the cluster.

Then, the second embodiment calculates the number of occurrence points belonging to the cluster corresponding to an ambulance. The second embodiment also extracts each of occurrence points belonging to the cluster in which the number of occurrence points assigned to the cluster corresponding to the ambulance is larger than a preset number. Then, the second embodiment calculates the risk level depending on the number of extracted occurrence points. A specific description thereof is now given.

In the second embodiment, the calculation unit 106 sets each of a plurality of ambulances to be each of the centers of a plurality of clusters.

The calculation unit 106 subsequently specifies a target ambulance representing an ambulance with the shortest distance to an occurrence point among a plurality of ambulances, which is similar to the first embodiment. The target ambulance is specified for each occurrence point in the predictive distribution generated by the demand prediction unit 102. The calculation unit 106 then assigns the occurrence points to the center of the cluster corresponding to the target ambulance.

In this regard, a target ambulance aᵢ for an occurrence point i is expressed by formula (2) below.

$$\begin{matrix}[ Math . 2 ] & \\ {a}_{i} = arg {min}_{j} {d}_{ij} & ( 2 )\end{matrix}$$

Moreover, given that the cluster of ambulance j is Cⱼ, then Cⱼ={i|aᵢ=j}.

The calculation unit 106 subsequently extracts each of the occurrence points where the distance dᵢ between the target ambulance aᵢ and the occurrence point i is equal to or greater than the threshold value dₜₕ, which is similar to the first embodiment. In addition, the calculation unit 106 extracts each of the occurrence points belonging to the cluster in which the number of the assigned occurrence points is larger than the preset number.

A specific description thereof is now given.

Specifically, the calculation unit 106 first sets a positive constant bⱼ to the cluster Cⱼ of the ambulance j for each of the plurality of ambulances. The calculation unit 106 subsequently initializes by substituting zero for a counter cⱼ corresponding to the cluster Cⱼ of the ambulance j. Moreover, the constant bⱼ can be designed to increase as the number of occurrence points to be processed by the ambulance j or the number of elements in N increases. A supplementary description for one of the meanings of the constant bⱼ is given below. The constant bⱼ can be regarded as the capacity for the demand of an ambulance. In other words, it is assumed that the capacity varies depending on the ambulance or regional characteristics. Thus, the constant bⱼ can be designed depending on the ambulance or the place where the present embodiment is implemented.

The calculation unit 106 subsequently rearranges the distance dᵢ calculated for each of the plurality of occurrence points in ascending order. The calculation unit 106 then compares each of all the distances dᵢ belonging to the set N with the threshold value dₜₕ in order from the smallest distance dᵢ.

If the distance dᵢ is equal to or greater than the threshold value dₜₕ, the calculation unit 106 extracts the occurrence point i. On the other hand, if the distance dᵢ is less than the threshold value dₜₕ, the calculation unit 106 increments the counter cⱼ of the cluster Cⱼ to which the occurrence point i belongs by one.

The calculation unit 106 then compares the counter cⱼ of the cluster Cⱼ with the positive constant bⱼ, and if bⱼ<cⱼ, extracts each occurrence point belonging to the cluster Cⱼ. Moreover, it is also possible to have a configuration of extracting the overflowing occurrence point instead of the occurrence point belonging to the cluster Cⱼ in which bⱼ<cⱼ in this way. The overflowing occurrence point is, for example, an occurrence point that does not belong to any clusters in the case where the number of occurrence points belonging to the cluster Cⱼ exceeds the integer bⱼ. The occurrence point belonging to the cluster Cⱼ is determined on the basis of the predetermined reference, such as its location or time.

This achieves the configuration makes it easier to dispatch the ambulance j corresponding to the cluster Cⱼ in which the number of the assigned occurrence points, cⱼ, is larger than the preset value bⱼ. Thus, the risk level for a region of the mesh including the occurrence point belonging to such a cluster of ambulances is set to become higher.

Moreover, if the number of the assigned occurrence points cⱼ is larger than the preset value bⱼ, the calculation unit 106 can extract the occurrence point corresponding to the number of differences between the constant bⱼ and the number of the assigned occurrence points as the occurrence point that is incapable of being covered by the target ambulance.

Next, operations of the display control device 10 will be described.

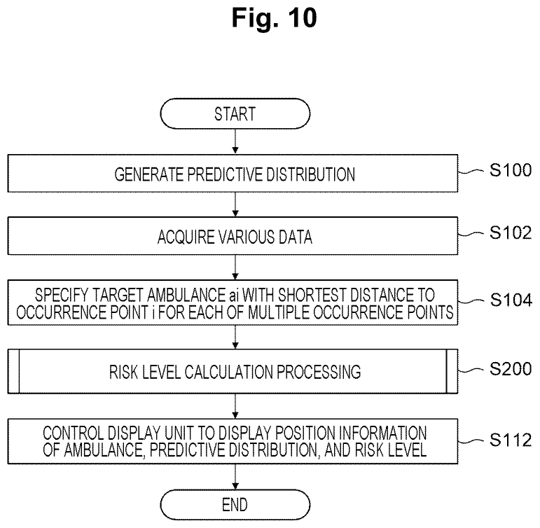

FIG. 10 is a flowchart illustrating procedures of display control processing by the display control device 10. The display control processing is performed by a CPU 11 reading a display control processing program from a ROM 12 or a storage 14, loading the display control processing program in a RAM 13, and executing the display control processing program.

Steps S100 to S104 and step S112 are executed similarly to those in the first embodiment.

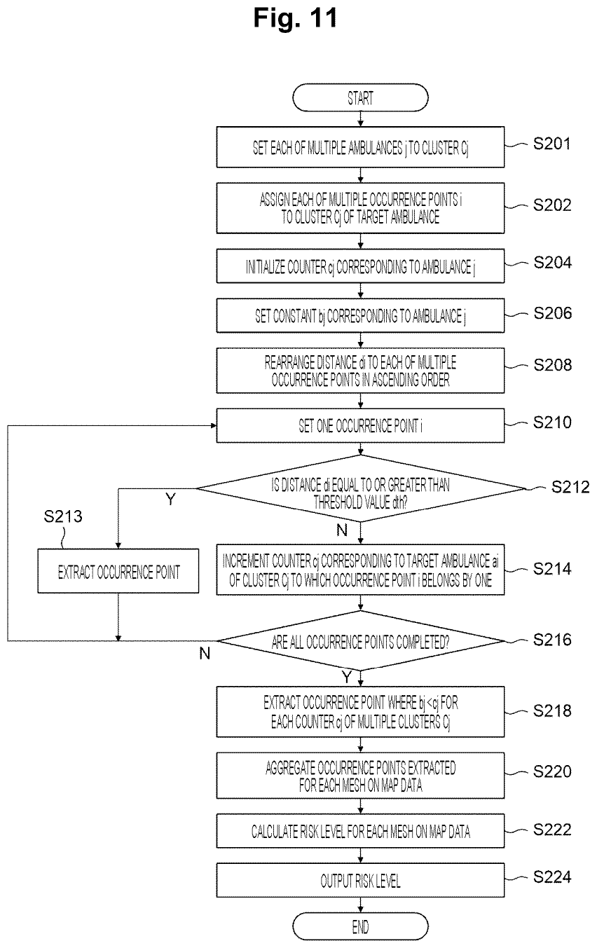

In step S200, the CPU 11 functions as the calculation unit 106 to calculate the risk level by executing the procedure of the flowchart illustrated in FIG. 11.

In step S201 of the flowchart illustrated in FIG. 11, the CPU 11 functions as the calculation unit 106 to set each of the plurality of ambulances j to be each of the centers of the plurality of clusters Cⱼ.

In step S202, the CPU 11 functions as the calculation unit 106 to assign each of the plurality of occurrence points i to the cluster Cⱼ of the target ambulance aᵢ.

In step S204, the CPU 11 functions as the calculation unit 106 to initialize the counter cⱼ corresponding to the ambulance j.

In step S206, the CPU 11 functions as the calculation unit 106 to set the constant bⱼ corresponding to the ambulance j.

In step S208, the CPU 11 functions as the calculation unit 106 to rearrange the distances dᵢ to the plurality of occurrence points in ascending order.

In step S210, the CPU 11 functions as the calculation unit 106 to set the occurrence point i.

In step S212, the CPU 11 functions as the calculation unit 106 to determine whether or not the distance dᵢ corresponding to the occurrence point i that is set in step S210 is equal to or greater than the threshold value dₜₕ. If the distance dᵢ is equal to or greater than the threshold value dₜₕ, the processing proceeds to step S213. On the other hand, if the distance dᵢ is less than the threshold value dₜₕ, the processing proceeds to step S214.

In step S213, the CPU 11 functions as the calculation unit 106 to extract the occurrence point i set in step S210, and then the processing returns to step S210.

In step S214, the CPU 11 functions as the calculation unit 106 to increment the counter cⱼ corresponding to the target ambulance aᵢ of the cluster Cⱼ to which the occurrence point i belongs by one.

In step S216, the CPU 11 functions as the calculation unit 106 to determine whether or not the processing of steps S201 to S214 is completed for all the occurrence points. If the processing of steps S210 to S214 is completed for all the occurrence points, the processing proceeds to step S218. If there is an occurrence point where the processing of steps S210 to S214 is not completed, the processing returns to step S210.

In step S218, the CPU 11 functions as the calculation unit 106 to extract the occurrence point where bⱼ<cⱼ for each of the counter cⱼ of the plurality of clusters Cⱼ on the basis of the value of the counter in the step S214.

In step S220, the CPU 11 functions as the calculation unit 106 to aggregate the occurrence points extracted in step S213 and step S218 for each mesh on the map data.

In step S222, the CPU 11 functions as the calculation unit 106 to calculate the risk level for each mesh on the basis of the aggregation result obtained in step S220.

In step S224, the CPU 11 functions as the calculation unit 106 to output the risk level calculated in step S222.

Note that other configurations and operations of the display control device according to the second embodiment are similar to those of the first embodiment, and thus, description thereof is omitted.

According to the second embodiment described above, the display control device sets each of the plurality of ambulances to be each of the centers of the plurality of clusters. The display control device also specifies the target ambulance representing the ambulance with the shortest distance to the occurrence point among multiple ambulances for each occurrence point in the predictive distribution. The display control device also assigns the occurrence point to the center of the cluster corresponding to the target ambulance. The display control device then extracts each of the occurrence points where the distance between the target ambulance and the occurrence point is equal to or greater than the threshold value and extracts each of the occurrence points belonging to the cluster in which the number of the assigned occurrence points is larger than the preset number. The display control device plots the extracted occurrence points on the map data partitioned into the plurality of meshes, calculating the risk level. In other words, according to the second embodiment, the display control device makes it possible to calculate the risk level obtained by associating the occurrence point with the number of ambulances that can cover the occurrence point. This risk level can incorporate the number of occurrence points that can be covered by the ambulance. This configuration makes it possible to visualize the risk level in consideration of the ease of dispatching an ambulance.

### Third Embodiment

Next, a third embodiment will be described. The third embodiment differs from the first and second embodiments in that the degree of dispatch, which indicates the ease of dispatching the ambulance, is further displayed. Note that a display control device according to the third embodiment has a configuration similar to that of the first embodiment, and the same reference numerals are given and description thereof is omitted.

The calculation unit 106 calculates the number of occurrence points having an ambulance specified as the target ambulance for each of the plurality of ambulances.

The calculation unit 106 then calculates the degree of dispatch for each of the plurality of ambulances so that the larger the number of occurrence points, the higher the degree of dispatch that indicates the ease of dispatching the ambulance depending on the number of occurrence points calculated for the ambulance. In addition, the calculation unit 106 calculates the degree of dispatch so that the smaller the number of occurrence points, the lower the degree of dispatch.

The display control unit 108 then controls the display unit 16 to further display the degree of dispatch calculated for each of the plurality of ambulances. Moreover, the display can be performed in the form of a numerical value of the degree of dispatch or color-coded display.

Next, operations of the display control device 10 will be described.

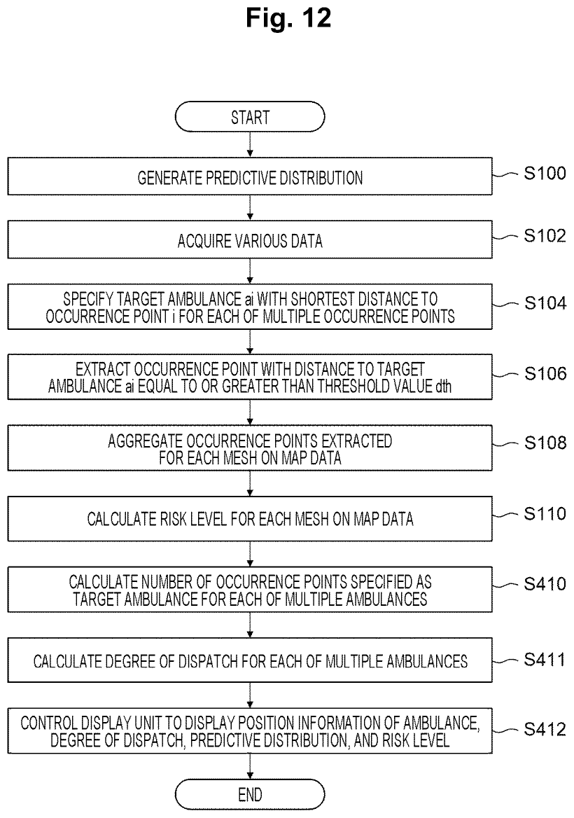

FIG. 12 is a flowchart illustrating procedures of display control processing by the display control device 10. The display control processing is performed by a CPU 11 reading a display control processing program from a ROM 12 or a storage 14, loading the display control processing program in a RAM 13, and executing the display control processing program.

Steps S100 to S110 are executed similarly to those in the first embodiment.

In step S410, the CPU 11 functions as the calculation unit 106 to calculate the number of occurrence points where an ambulance is specified as the target ambulance for each of the plurality of ambulances.

In step S411, the CPU 11 functions as the calculation unit 106 to calculate the degree of dispatch for each of the plurality of ambulances so that the larger the number of occurrence points, the higher the degree of dispatch that indicates the ease of dispatching the ambulance depending on the number of occurrence points calculated for the ambulance on the basis of the calculation result obtained in the above step S410. In addition, the calculation unit 106 calculates the degree of dispatch so that the smaller the number of occurrence points, the lower the degree of dispatch.

In step S412, the CPU 11 functions as the display control unit 108 to control the display unit 16 to further display the degree of dispatch, which is calculated for each of the plurality of ambulances and obtained in step S411.

Note that other configurations and operations of the display control device according to the third embodiment are similar to those of the first or second embodiment, and thus, description thereof is omitted.

According to the third embodiment described above, the display control device calculates the number of occurrence points where an ambulance is specified as the target ambulance for each of the plurality of ambulances. The display control device then calculates the degree of dispatch for each of the plurality of ambulances so that the larger the number of occurrence points, the higher the degree of dispatch that indicates the ease of dispatching the ambulance depending on the number of occurrence points calculated for the ambulance. In addition, the display control device calculates the degree of dispatch so that the smaller the number of occurrence points, the lower the degree of dispatch. The display control device then controls the display unit to further display the degree of dispatch calculated for each of the plurality of emergency vehicles. This configuration makes it possible to further visualize the ease of dispatching the ambulance. In addition, there can be a case where the deployment of some ambulances is to vary, such as a case where the demand for calls fluctuates in some areas. In this case, the visualization can be performed by moving ambulances in order, starting from an ambulance that is easy to dispatch, i.e., an ambulance with fewer occurrence points to cover and by displaying them as candidate ambulances.

Alternatively, there can be a case where the number of occurrence points covered by all ambulances is less than or equal to the predetermined threshold value. In this case, the visualization can be performed by moving all the ambulances as candidate ambulances

The display control processing, which is performed by the CPU reading software (program) in each of the above embodiments, may be performed by various processors other than the CPU. Examples of the processor in this case include a programmable logic device (PLD) in which a circuit configuration can be changed after manufacturing such as a field-programmable gate array (FPGA), and a dedicated electric circuit that is a processor having a circuit configuration exclusively designed for performing specific processing such as an application specific integrated circuit (ASIC). In addition, the display control processing may be performed by one of these various processors, or may be performed by a combination of two or more processors of the same type or different types (for example, a plurality of FPGAs, a combination of a CPU and an FPGA, and the like). In addition, the hardware structure of these various processors is, more specifically, an electric circuit in which circuit elements such as semiconductor elements are combined.

In each of the above embodiments, the aspect in which the display control processing program is stored (installed) in advance in the storage 14 has been described, but this is not restrictive. The program may be provided in a form stored in a non-transitory storage medium such as a compact disk read only memory (CD-ROM), a digital versatile disk read only memory (DVD-ROM), and a universal serial bus (USB) memory. The program may be downloaded from an external device via a network.

Further, the above embodiment describes the case where an emergency vehicle is targeted as an example, but the present embodiment is not limited to this exemplary case. In one example, it is possible to employ the present embodiment as long as it is such as a call by a moving body depending on a predetermined demand. Thus, the above embodiment describes the case where the emergency vehicle is an ambulance as an example, but the present embodiment is not limited to this exemplary case. In one example, the emergency vehicle can be a police vehicle.

Further, the above embodiment describes the case where the risk level is calculated depending on the distance representing the distance between the emergency vehicle and the occurrence point as an example, but the present embodiment is not limited to this exemplary case. In one example, the risk level can be calculated depending on the time required from the occurrence of the emergency vehicle call to the arrival of the emergency vehicle at the occurrence point. In this case, for example, when the time required from the call of the emergency vehicle to the arrival of the emergency vehicle at the occurrence point is equal to or longer than a predetermined threshold value, the occurrence point is extracted and plotted on the map data.

Further, the above embodiment describes the case where the risk level is calculated using the latitude and longitude information of the occurrence point representing the point where the ambulance call occurs as an example, but the present embodiment is not limited to this exemplary case. In one example, the risk level can be calculated by treating one mesh on the map data as one occurrence point. In this case, for example, an expected value for calling an ambulance in one mesh can be calculated on the basis of past information, and the risk level can be calculated using the expected value.

Further, the second embodiment describes the example of extracting the occurrence points belonging to the cluster in which the number of occurrence points belonging to the cluster is larger than the preset number, calculating the risk level on the basis of the extracted occurrence points. However, the present embodiment is not limited to this example. In one example, it is possible to provide a configuration of excluding an ambulance corresponding to clusters in which the number of occurrence points belonging to the cluster is larger than the preset number and setting the excluded ambulances not to be available for dispatch, performing the clustering again. In this case, the distance dᵢ and the target ambulance aᵢ are calculated again for each of the occurrence points i for which it is not determined whether or not it belongs to the cluster Cⱼ. Then, the occurrence point i is assigned to the cluster Cⱼ of the ambulance j corresponding to the target ambulance aᵢ. Then, as in the second embodiment, if the distance dᵢ is equal to or greater than the threshold value dₜₕ, the occurrence point i is extracted, and if the distance dᵢ is less than the threshold value dₜₕ, the counter cⱼ of the cluster Cⱼ to which the occurrence point i belongs increments by one. The repetition of the processing allows the risk level to be calculated more appropriately. Moreover, such repetitive processing can end when the termination condition is satisfied, such as, for example, extraction of more than a predetermined number of occurrence points, belonging of a certain number or less of occurrence points to one cluster, or, being the number of occurrence points less than or equal to a predetermined number that does not belong to any cluster. In addition, an example of the termination condition can include a termination condition that determines to belong to any cluster when the occurrence point is the target, a termination condition that determine to fail to belong to any cluster (e.g., if there is no ambulance that can be covered, or if the distance from any ambulance exceeds the threshold value), or the like.

Further, the above embodiment describes the case where the risk level is calculated for each mesh as an example, but the present embodiment is not limited to this exemplary case. In one example, the risk level can be calculated for each point. Alternatively, the risk level can be displayed in a format such as contour lines.

With regard to the above embodiments, the following supplementary notes are further disclosed.

### (Supplementary Note 1)

A display control device including:
a memory; and
at least one processor connected to the memory, in which
the processor is configured to
control a display unit to display position information of an emergency vehicle, a predictive distribution of an occurrence point, and a risk level, the occurrence point representing a point at which a call for the emergency vehicle occurs, the risk level being determined depending on a time required for the emergency vehicle to arrive at the occurrence point after the call for the emergency vehicle occurs or a distance between the emergency vehicle and the occurrence point.

### (Supplementary Note 2)

A non-transitory storage medium storing a program executable by a computer to execute display control processing,
the display control processing including:
controlling a display unit to display position information of an emergency vehicle, a predictive distribution of an occurrence point, and a risk level, the occurrence point representing a point at which a call for the emergency vehicle occurs, the risk level being determined depending on a time required for the emergency vehicle to arrive at the occurrence point after the call for the emergency vehicle occurs or a distance between the emergency vehicle and the occurrence point.

### REFERENCE SIGNS LIST

100 Acquisition unit
101 Data storage unit
102 Demand prediction unit
104 Situation acquisition unit
106 Calculation unit
108 Display control unit

1. A display control device comprising a processor configured to execute operation comprising:
causing display of position information of an emergency vehicle, a predictive distribution points associated with an occurrence point, and a risk level, wherein the occurrence point represents a point at which a call for the emergency vehicle occurs, the risk level depends on at least one of:
a time required for the emergency vehicle to arrive at the occurrence point after the call for the emergency vehicle occurs, or
a distance between the emergency vehicle and the occurrence point.

2. The display control device according to claim 1, the processor further configured to execute operations comprising:
calculating the risk level, wherein the risk level is determined based on at least one of:
a time required for one of a plurality of emergency vehicles to arrive at the occurrence point, or
a distance between one of the plurality of emergency vehicles and the occurrence point based on the position information of the plurality of emergency vehicles and the predictive distribution of points associated with the occurrence point,
wherein the causing displaying of position information of an emergency vehicle further comprises causing display of a combination comprising:
the position information of the plurality of emergency vehicles, the predictive distribution, and the calculated risk level.

3. The display control device according to claim 2, wherein
the calculating further comprises:
specifying a target emergency vehicle among the plurality of emergency vehicles for each of the plurality of occurrence points in the predictive distribution, the target emergency vehicle representing at least one of:
the emergency vehicle with a time shorter than any other times required to arrive at the occurrence point, or
the emergency vehicle with a distance shorter than any other distances to the occurrence point,
extracting the occurrence point in which at least one of:
a time required for the target emergency vehicle to arrive at the occurrence point, or
a distance between the target emergency vehicle and the occurrence point is equal to or greater than a threshold value among the plurality of occurrence points, and
calculating the risk level for each mesh included in map data in such a way to increase the risk level as a number of occurrence points included in the mesh is larger and to decrease the risk level as the number of occurrence points included in the mesh is smaller, and
wherein the causing display further comprises causing display of the risk level for each of the meshes included in the map data.

4. The display control device according to claim 3, wherein
the calculating further comprises:
setting each of the plurality of emergency vehicles as each of centers of a plurality of clusters,
specifying the target emergency vehicle among the plurality of emergency vehicles for each of the occurrence points in the predictive distribution,
assigning the occurrence point to the center of the cluster corresponding to the target emergency vehicle, the target emergency vehicle representing at least one of:
the emergency vehicle with a time shorter than any other times required to arrive at the occurrence point, or
the emergency vehicle with a distance shorter than any other distances to the occurrence point,
extracting each of the occurrence points in which at least one of:
the time required for the target emergency vehicle to arrive at the occurrence point, or
the distance between the target emergency vehicle and the occurrence point is equal to or greater than the threshold value, and
when a number of the assigned occurrence points is greater than a determined number, extracting the occurrence point corresponding to a number of differences between the predetermined number and the number of the assigned occurrence points as an occurrence point incapable of being covered by the target emergency vehicle.

5. The display control device according to claim 3, wherein
the calculating further comprises:
calculating a number of occurrence points at which an emergency vehicle of interest of the plurality of emergency vehicles is specified as the target emergency vehicle for each of the plurality of emergency vehicles, and
calculating a degree of dispatch indicating ease of dispatch of the emergency vehicle for each of the plurality of emergency vehicles depending on a number of occurrence points calculated for the emergency vehicle in such a way to increase the degree of dispatch as the number of occurrence points is larger and decrease the degree of dispatch as the number of occurrence points is smaller, and
wherein the causing display further comprises causing display of the degree of dispatch calculated for each of the plurality of emergency vehicles.

6. A computer implemented method for causing display, comprising:
causing display of position information of an emergency vehicle, a predictive distribution points associated with an occurrence point, and a risk level, the occurrence point representing a point at which a call for the emergency vehicle occurs, and the risk level depending on at least one of:
a time required for the emergency vehicle to arrive at the occurrence point after the call for the emergency vehicle occurs, or
a distance between the emergency vehicle and the occurrence point.

7. A computer-readable non-transitory recording medium storing computer-executable program instructions that when executed by a processor cause a computer system to execute operations comprising:
causing display of position information of an emergency vehicle, a predictive distribution of points associated with an occurrence point, and a risk level, wherein the occurrence point represents a point at which a call for the emergency vehicle occurs, the risk level depends on at least one of:
a time required for the emergency vehicle to arrive at the occurrence point after the call for the emergency vehicle occurs, or
a distance between the emergency vehicle and the occurrence point.

8. The display control device according to claim 1, wherein the predictive distribution of points is based on sampling points in a plurality of regions indicating a mesh in map data.

9. The display control device according to claim 1, wherein the risk level corresponds to a region in a plurality of regions indicating a mesh in map data.

10. The display control device according to claim 4, wherein
the calculating further comprises:
calculating a number of occurrence points at which an emergency vehicle of interest of the plurality of emergency vehicles is specified as the target emergency vehicle for each of the plurality of emergency vehicles, and
calculating a degree of dispatch indicating ease of dispatch of the emergency vehicle for each of the plurality of emergency vehicles depending on a number of occurrence points calculated for the emergency vehicle in such a way to increase the degree of dispatch as the number of occurrence points is larger and decrease the degree of dispatch as the number of occurrence points is smaller, and
wherein the causing display further comprises causing display of the degree of dispatch calculated for each of the plurality of emergency vehicles.

11. The computer implemented method according to claim 6, further comprising:
calculating the risk level, wherein the risk level is determined based on at least one of:
a time required for one of a plurality of emergency vehicles to arrive at the occurrence point, or
a distance between one of the plurality of emergency vehicles and the occurrence point based on the position information of the plurality of emergency vehicles and the predictive distribution of points associated with the occurrence point,
wherein the causing displaying of position information of an emergency vehicle further comprises causing display of a combination comprising:
the position information of the plurality of emergency vehicles, the predictive distribution, and the calculated risk level.

12. The computer implemented method according to claim 6, wherein the predictive distribution of points is based on sampling points in a plurality of regions indicating a mesh in map data.

13. The computer implemented method according to claim 6, wherein the risk level corresponds to a region in a plurality of regions indicating a mesh in map data.

14. The computer implemented method according to claim 11, wherein the calculating further comprises:
specifying a target emergency vehicle among the plurality of emergency vehicles for each of the plurality of occurrence points in the predictive distribution, the target emergency vehicle representing at least one of:
the emergency vehicle with a time shorter than any other times required to arrive at the occurrence point, or
the emergency vehicle with a distance shorter than any other distances to the occurrence point,
extracting the occurrence point in which at least one of:
a time required for the target emergency vehicle to arrive at the occurrence point, or
a distance between the target emergency vehicle and the occurrence point is equal to or greater than a threshold value among the plurality of occurrence points, and
calculating the risk level for each mesh included in map data in such a way to increase the risk level as a number of occurrence points included in the mesh is larger and to decrease the risk level as the number of occurrence points included in the mesh is smaller, and
wherein the causing display further comprises causing display of the risk level for each of the meshes included in the map data.

15. The computer implemented method according to claim 14, wherein the calculating further comprises:
setting each of the plurality of emergency vehicles as each of centers of a plurality of clusters,
specifying the target emergency vehicle among the plurality of emergency vehicles for each of the occurrence points in the predictive distribution,
assigning the occurrence point to the center of the cluster corresponding to the target emergency vehicle, the target emergency vehicle representing at least one of:
the emergency vehicle with a time shorter than any other times required to arrive at the occurrence point, or
the emergency vehicle with a distance shorter than any other distances to the occurrence point,
extracting each of the occurrence points in which at least one of:
the time required for the target emergency vehicle to arrive at the occurrence point, or
the distance between the target emergency vehicle and the occurrence point is equal to or greater than the threshold value, and
when a number of the assigned occurrence points is greater than a determined number, extracting the occurrence point corresponding to a number of differences between the predetermined number and the number of the assigned occurrence points as an occurrence point incapable of being covered by the target emergency vehicle.

16. The computer-readable non-transitory recording medium according to claim 7, the computer-executable program instructions when executed further causing the computer system to execute operations comprising:
calculating the risk level, wherein the risk level is determined based on at least one of:
a time required for one of a plurality of emergency vehicles to arrive at the occurrence point, or
a distance between one of the plurality of emergency vehicles and the occurrence point based on the position information of the plurality of emergency vehicles and the predictive distribution of points associated with the occurrence point,
wherein the causing displaying of position information of an emergency vehicle further comprises causing display of a combination comprising:
the position information of the plurality of emergency vehicles, the predictive distribution, and the calculated risk level.

17. The computer-readable non-transitory recording medium according to claim 7, wherein the predictive distribution of points is based on sampling points in a plurality of regions indicating a mesh in map data.

18. The computer-readable non-transitory recording medium according to claim 7, wherein the risk level corresponds to a region in a plurality of regions indicating a mesh in map data.

19. The computer-readable non-transitory recording medium according to claim 16, wherein
the calculating further comprises:
specifying a target emergency vehicle among the plurality of emergency vehicles for each of the plurality of occurrence points in the predictive distribution, the target emergency vehicle representing at least one of:
the emergency vehicle with a time shorter than any other times required to arrive at the occurrence point, or
the emergency vehicle with a distance shorter than any other distances to the occurrence point,
extracting the occurrence point in which at least one of:
a time required for the target emergency vehicle to arrive at the occurrence point, or
a distance between the target emergency vehicle and the occurrence point is equal to or greater than a threshold value among the plurality of occurrence points, and
calculating the risk level for each mesh included in map data in such a way to increase the risk level as a number of occurrence points included in the mesh is larger and to decrease the risk level as the number of occurrence points included in the mesh is smaller, and
the causing display further comprising causing display of the risk level for each of the meshes included in the map data.

20. The computer-readable non-transitory recording medium according to claim 19, wherein the calculating further comprises:
setting each of the plurality of emergency vehicles as each of centers of a plurality of clusters,
specifying the target emergency vehicle among the plurality of emergency vehicles for each of the occurrence points in the predictive distribution,
assigning the occurrence point to the center of the cluster corresponding to the target emergency vehicle, the target emergency vehicle representing at least one of:
the emergency vehicle with a time shorter than any other times required to arrive at the occurrence point, or
the emergency vehicle with a distance shorter than any other distances to the occurrence point,
extracting each of the occurrence points in which at least one of:
the time required for the target emergency vehicle to arrive at the occurrence point, or
the distance between the target emergency vehicle and the occurrence point is equal to or greater than the threshold value, and
when a number of the assigned occurrence points is greater than a determined number, extracting the occurrence point corresponding to a number of differences between the predetermined number and the number of the assigned occurrence points as an occurrence point incapable of being covered by the target emergency vehicle.
